(19) United States
(12) Patent Application Publication
(10) Pub. No.: US 2002/0065881 A1
(43) Pub. Date: May 30, 2002

(54) Wireless family bulletin board

(76) Inventors: Tapio Mansikkaniemi, Espoo (FI); Turkka Keinonen, Huhmari (FI); Harri Wikberg, Helsinki (FI); Anne Koppinen, Tampere (FI); Anna Valtonen, Helsinki (FI)

Correspondence Address: ANTONELLI, TERRY, STOUT & KRAUS, LLP, SUITE 1800, 1300 NORTH SEVENTEENTH STREET, ARLINGTON, VA, 22209, US

(21) Appl. No.: 09/725,249

(22) Filed: Nov. 29, 2000

(51) Int. Cl. G06F 15/16

(52) U.S. Cl. 709/204

(57) ABSTRACT

An electronic bulletin board which can be accessed by members of a family from their wireless devices. The wireless devices for various members of the family can access a common database, which produces an appearance of a bulletin board having notes attached thereto. The notes may be generated manually, may be generated from e.g. a calendar, or may be the result of a short message service contact. The notes may be of various colors to indicate their origin or importance. The notes may be moved around on the board and any member of the family may generate new notes.

### RELATED APPLICATION(S)

This application is related to co-pending application Ser. No. 09/607,638, filed Jun. 30, 2000, entitled “Method and Apparatus for Touch Screen Input” and an application Ser. No. 09/607,637 filed on Sep. 11, 2000 and later on filed continuing application Ser. No. 09/659,416, filed Sep. 11, 2000, entitled “Network with Mobile Terminals as Browsers having wireless access to the Internet and Method for Using the Same” and Ser. No. 09/609,581 filed Jun. 30, 2000 entitled “Network with Mobile Terminals Having Wireless Access to the Internet and Method for Using Same” and Ser. No. 09/607,369 filed Jun. 30, 2000 entitled “User Interface Constructed from Components Created from Set of TAGs” and U.S. Ser. No. 09/608,174 filed Jun. 30, 2000 entitled “Handheld Terminal with Multiple Scrolling Means” and Ser. No. 09/607,359 filed Jun. 30, 2000 entitled “System and Method for Providing a Virtual Keyboard for a Wireless Terminal”. This application is also related to other applications (Attorney Docket Nos. 017.38954X00 through 017.38961X00). These are all assigned to and commonly owned by Nokia Corporation and are herein incorporated by reference.

### BACKGROUND OF THE INVENTION

1. Field of the Invention

This invention relates generally to an electronic bulletin board and, more particularly, to a wireless bulletin board for a family.

2. Discussion of the Background

Portable communication devices such as wireless telephones have become very popular and increasingly are able to provide much more than mere telephone access. Such devices have been developed which allow a user to access communication networks such as the Internet from their wireless device.

Such a system has been described in co-pending U.S. patent application Ser. No. 09/607,638 (and in its continuing patent application Ser. No. 09/659,416, filed Sep. 11, 2000, which describes a mobile display appliance system, which allows access to the Internet from a variety of wireless terminals. In addition to individual access, the server also provides a family level of interaction as also described in co-pending U.S. patent application Ser. No. 09/607,637 filed on Jun. 30, 2000 so that a prearranged group of terminals may all is allowed access to a common group of information. Accordingly, an individual user may be recognized as having access not only to his own information, but also to common information provided to the family.

Such a system is shown in FIG. 1, where the network 10 includes terminals 20,20a, and 20b, each coupled over a wireless system to an access point 22 or 22a. The access point is coupled to a network e.g. owned by an operator like an Internet service provider 24, which is coupled to the Internet 26. In addition, the Internet service provider 24 is coupled to a mobile display appliance server 28 that provides the users with specific services and features through their wireless terminals. Alternatively, the access point 22 can be connected directly to server 28 via any network connection.

It is also possible that a terminal 20c outside the service area of access point 22 may be connected to server 28 by instead being in the vicinity of another access point 42, which then is connected to server 28 through Internet service provider 44, and the Internet or other network. The access point 22, 22a and 42 is also coupled to a global unit or product vendor 34. This may be a direct coupling through a link or may be coupled through a landline and Internet service provider 24 or 44. The terminal knows the address of global address registry 36 with a global unit. A direct connection is established between terminal via a network access point or server of Internet Service Provider 24 or 44. As according to one alternative addressing scheme to this chosen exemplary system environment of the invention, an address of a server 28 is received to terminal and the network node, where from the request to global register was made. The initial configuration information and or the configuration of a direct link is loaded down to the terminal from the remote server to the terminal where it was stored as part of the configuration information. This information can be updated from e.g. the Internet service provider, access service provider or mobile service provider from time to time. The configuration and the addressing of the terminal in the system as well as any direct address link configured to the terminal user interface is also updated down to a remote server when it is changed. The global unit 34 includes a global address server 36 and a global upgrade server 38. The vendor of the system terminal is connected either directly via network e.g. the Internet to each remote server 28 or connected in a more centralized way first to the server of the terminal vendor and from there onto each server 28. The advantage of having the terminals store the Internet address of the global address server 36 is that if the terminal 20 is relocated near another access point, then the terminal 20 may still obtain the Internet access location of server 28 simply by knowing the Internet address of the global address server 36. It would also be possible, to instead have a system where the address of the server 28 is stored in the terminal 20 and the memory updated as needed. The server 28 authenticates, using the unique identity of the terminal 20, that the terminal 20 has shared or group access privileges. Accordingly, the terminal 20 is authenticated and logged onto the server 28 to begin a shared session at a shared or group level.

While this system and other similar wireless devices provide a number of useful and interesting services, it would be helpful for members of the family to have access to a central display onto which messages are placed which are of common interest. In previous systems, such as U.S. Pat. No. 5,874,950, notes can be saved in user specific workspaces. However, this does not allow for common notes to be viewed by a family.

### SUMMARY OF THE INVENTION

Accordingly, the present invention provides a wireless system having access to a family bulletin board.

The present invention also provides a wireless network system for a family to interact through a bulletin board.

This invention further provides a method for allowing members of the family to interconnect through a bulletin board.

The present invention still further provides an electronic bulletin board having notes of different colors with different indicia to indicate topics, sources, etc.

This is achieved by providing an access point connected to an Internet service provider, which provides access to a server. The server provides the family members with the bulletin board data. The individual wireless devices are connected through the access point in order to access the common information.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a block diagram showing the wireless network according to the present invention; and

FIG. 2 is a diagram showing various parts of a wireless terminal according to the present invention; and

FIG. 3 shows a server of a system; and

FIG. 4 is a view showing the main display of the bulletin board; and

FIG. 5 is a view showing the display of a bulletin board when making a new note; and

FIG. 6 is a view of the bulletin board showing the listing of notes.

### DESCRIPTION OF THE PREFERRED EMBODIMENTS

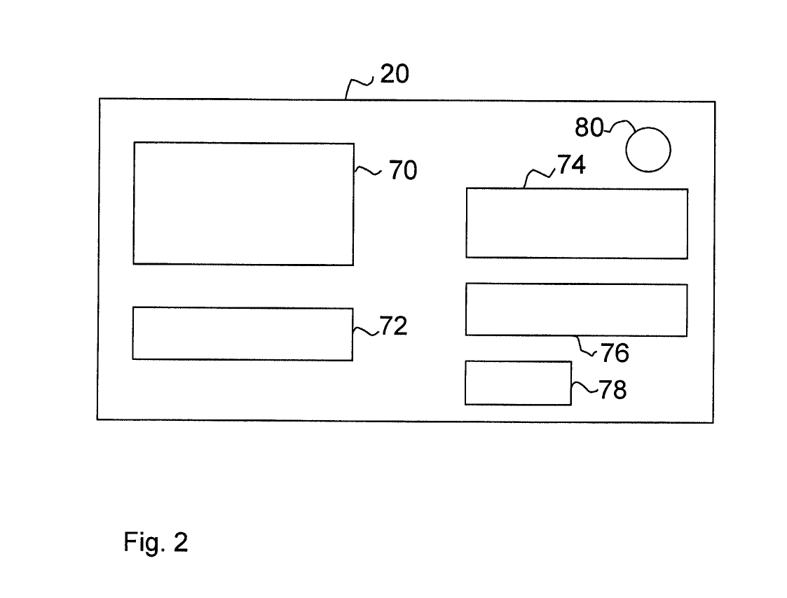

Referring now to the drawings, wherein like reference numerals designate identical or corresponding parts throughout the several views, and more particularly to FIG. 2 thereof, wherein the terminal 20 is shown. This figure shows the various parts of the terminal although it is not intended to show the actual physical relationship of the parts. The terminal 20 includes a visual display 70, a user interface 72, a browser 74, a driver 76 and hardware 78. In this system, the driver 76 resides in the memory of the hardware 78 along with other data and with software such as the browser software. When the terminal is turned on, the driver retrieves data relating to an Internet address of a global address server 36. Once the terminal is powered on, it is coupled to access point 22 and Internet service provider 24.

Button 80 can be actuated so that the virtual keyboard as well as the header and footer related to the services are presented. Thus, once this is pressed, the web page, which was a full screen display, would be reduced to a thumb nail view and positioned in display 70, such as in the bottom left corner of the footer. Thus, the user has a shortcut to quickly access the web page that was previously visited or to save that web page as a bookmark.

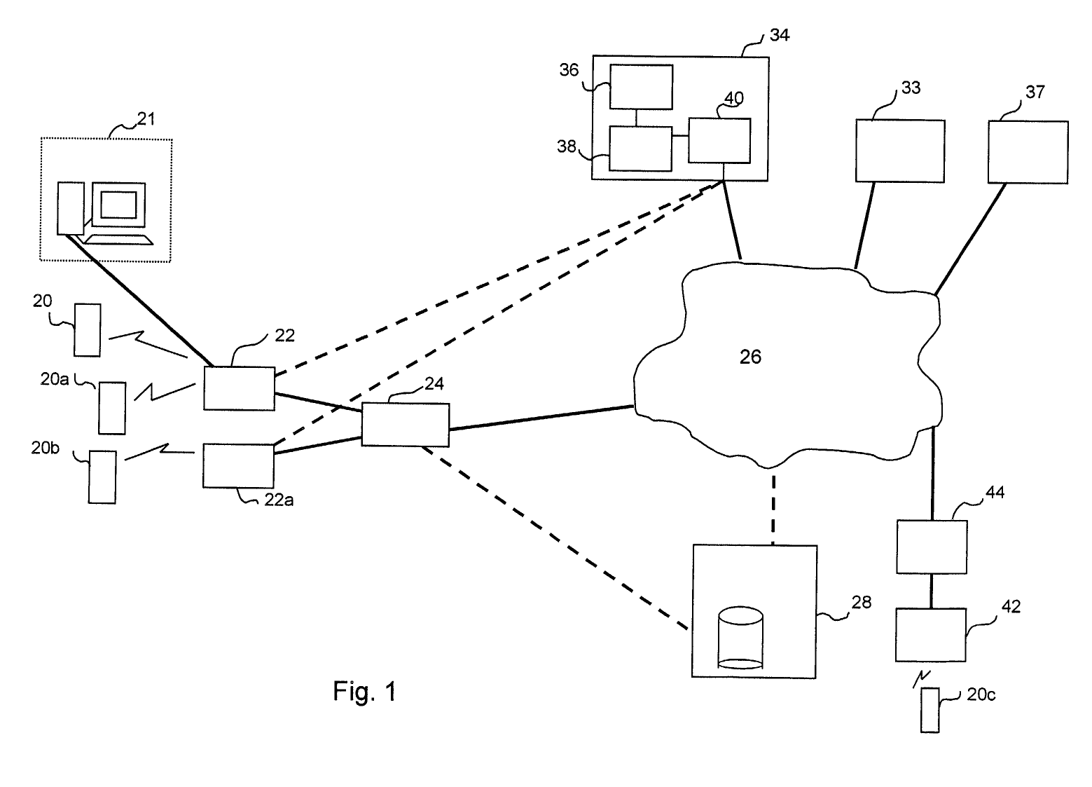

Using the address of server 36 in FIG. 1, the terminal is coupled to the server and sends a request in order to obtain the Internet address of server 28. Terminal 20 is then coupled to server 28. Once the terminal is connected to server 28, it is capable of interacting and receiving full services that are available in the system.

When the terminal is connected to the server, it proceeds to go through a usual process of authentication and the server determines which portions of its data the terminal is authorized to access.

After the terminal has been authenticated and the terminal has received the downloaded configuration information of services, user interface and links configured concerning the services and interface the main view of the user interface of the terminal, which is a part of the downloaded information to the terminal, the terminal is ready to be used. Then each terminal includes a unique identification (ID), the IDs are reserved and used by members belonging to the same group. Each of the unique identification of the terminals is recognised in the same server 28 to be used by the members of the group. Every member belonging to respective group may use same terminal. When one or more terminals each of the terminals including a unique terminal identification is switched on, then each terminal belonging to the same group request from the global address server 36 with terminal unique identification the address of the server 28 in which the applications and services are stored and ready to be used. Then each of the terminals belonging to the same group will get address of the same server 28 into which each of the terminals is connected. Thus, the user can now access services or retrieve information from the server 28 or the Internet 26. In addition the terminal to be used to access and use the services of the group the terminal can be used to access services of an individual user. In order for the user to initiate an individual session and retrieve individual information, the user must use the terminal 20 and provide further authentication to the server 28 to gain access at the individual level. As would be appreciated by one of ordinary skill in the art, either at shared/group or at individual level, the user is able to the retrieve the information related to the group of users as well as browse the Internet 26 to retrieve information. The mobile terminal to be used can be ordinary PC and a wireless modem being able to establish a wireless connection via a mobile service operator to the server 28 having capability to be in connection to the network. A mobile terminal can be such a terminal that is described in detail in any of the still secret patent applications U.S. Ser. Nos. 09/607,637, 09/659,416 or 09/609,581.

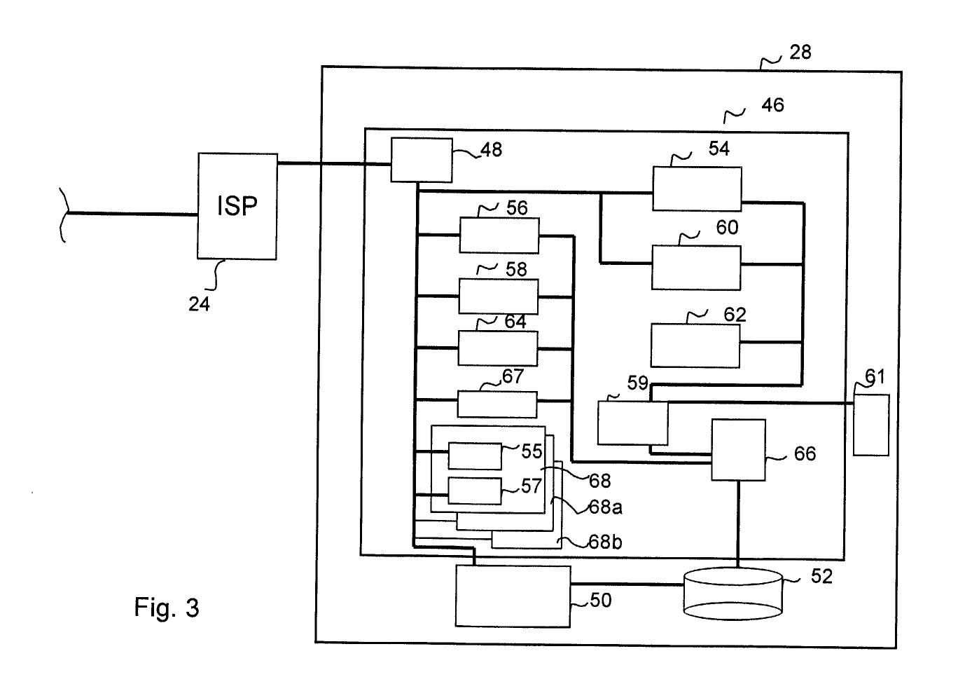

In FIG. 3 is a more detailed block diagram representation of the server of the system of the network shown in FIG. 1. In FIG. 3, the server 28 includes a support server 46, a response handler or application server 48, a network application server 50, and a directory server 52. As would be appreciated by one of ordinary skill in the art the referenced connections do not depict the physical connections between the elements but merely logical connections. The support server 46 provides services oriented towards enabling and supporting the services provided to the terminal 20. The support server 46 includes an upgrade service unit 54, a bookmark service database unit 55, a login services unit 56, a bookmark database 57, a profile services unit 58, a client log unit 59 for collecting information about clients, an advertisement services unit 60, a system log unit 61 for collecting information about events in the server 28 from the client log unit 59, an administrative services unit 62, a defined service unit 64, and a directory client unit 66.

Still referring to FIG. 3, the upgrade services unit 54 is dedicated to controlled software upgrade of the software for the support server 46. Updates are transmitted from the global upgrade server 38 (in FIG. 1) to the upgrade service unit 54. The login services unit 56 provides for authentication of the user and the terminal 20 that is being used to access the services based on information provided by the client unit 66. Additionally, the login services unit 56 is also responsible for log-off activities, such as individual session termination. The profile services unit 58 provides for modifying a user's profile information. This modification of a user's profile may include modifying the group and individual information and preferences. The administration services unit 62 provides for administration of the support server 46 and the application server 48. The software product updates are transmitted from the global upgrade server 38 (in FIG. 1) and its configuration tool manager to the upgrade service unit 54 in FIG. 3 and its configuration tool client. The configuration tool client is the function unit, that acts when any configuration tool manager 38 (in FIG. 1) of management server 37 (in FIG. 1) upgrades any software component, full executable software program or re-configures configuration parameters; application and system parameters.

In FIG. 1 a firewall 40 is protecting the connection to and from the global unit 34. It will be apparent to those skilled in the art that the firewall unit 40 functions to provide secured access to the global address server 36 and the global upgrade server 38.

In FIG. 3 The advertisement services unit 60 provides for the server 28 to tailor advertisements to the user and the terminal 20 according to the user's profile information. The defined services unit 64 is a classification of other services containing items such as bookmark management services, help services, and log services, name management services, and general management services. The directory client unit 66 is coupled to the directory server 52 to provide client verification.

In FIG. 3 the remote register management and control unit 67 that knows the closest or the global terminal validation register address and control unit 67 may also interpret the answer received from said register. Typically, in terminal in the browser login action, the server's 28 browser client specific parameters 68 are managed individually. That management information of one terminal browser session is stored and used when request is received from an identified terminal 20. Other requests received from terminals (20a or 20b) processing different identification information (IDs) will use browser client specific parameters (68a, 68b) and may result in, for instance, seeking of bookmarks for the terminal when action request originated from terminal.

In FIG. 1. the terminal may have access through proper authentication and service purchases to third party publications available from a vendor 33, such as news related information found in magazine publications or the daily newspaper.

The user interface of the terminal 20 (of FIG. 1) offers for the user alternative selections means to select command and a target to the command in main menu of the terminal view or in an application such as notice board that is used at a time.

The marker or selection means, that user can use one of the means in the following list; external mouse that is connected to the terminal, external keypad that is connected to the terminal, visual and virtual keypad that is displayed to the touch sensitive screen (and described in detail in the cross referenced patent application U.S. Ser. No. 09/607,359), direct manipulation selection arrangement made with fingertips or e.g. a pen to touch sensitive screen user interface selections (as described in detail in U.S. Ser. No. 09/607,638), the integrated roller(s) in the terminal and roller control buttons (as described in detail in a cross referenced patent application U.S. Ser. No. 09/607,359).

When the external mouse is used for marking the target into which user's commands are to be directed, marking the target of the command is done typically by pressing one button once (the left most button). Then application specific command is typically selected from a menu (like Edit menu) and then selected command affects the previously marked target of the command. (This basic mouse selection pattern is currently known in any PC.)

When an external keypad is used, the marking or selection concerning target of the selected command may be done by moving the active selection point to up, down, left or right with the “arrow buttons”. The actual selection or marking is then done by pressing <enter> button. Also alternative to moving the active marking with “arrow buttons” (→,←, . . . ) the marking point can be moved for instance by pressing “tab” button and the user interface of the application may move the active marking position from one target to another in such a way, that all the possible targets in one view, one at a time is available to be selected. Then the command that is to be processed for the selected target is typically given by pressing some button control like for instance <ctrl> button and in the same time a character button (like “W”) or two concatenation character button pressings (like “W” and “O”, the first character defining the menu set and the second the command in that menu set or the first character defining the command and the second target where to the response is directed e.g. save to memory). (This kind of marking and selection is known at present in any PC user interface.)

When the virtual keypad is used for the marking or selection marking the target and giving a command may be done similarly as above described external keypad case, but instead of using “arrow buttons” or “tabs” to select or mark the target and character or function buttons to give certain commands to selected target, the user may do the keypad button selection with his fingertips directly to display “the soft keys”. The soft keys are the keypad buttons drawn on the touch sensitive display to look like hard button keys of the keypad). (This virtual keypad means and methods are currently presented in at cross-referenced patent application U.S. Ser. No. 09/607,359.

When direct manipulation selection is used, the application that is used can be controlled from user interface by user making first selecting the target by directly touching the target area in the touch sensitive display. In the next step a menu of commands or a command button is selected (from the view if presented at the moment) and in the third step is when the given command is processed for the selected object. Possibly a status indication of the processed command is shown in the display of the user interface. (The direct manipulation methods are presented in currently secret patent applications U.S. Ser. No. 09/607,638.) The terminal 20 (in FIG. 1) user issues commands to the terminal 20 and the server 28 by using direct manipulation and from menu-type of UI controls (object menu, toolbar etc.). He either press the hardware or software button down, keeps his finger on hardware or software button for a longer period, moves his finger over the touch-sensitive touch screen and lifts his finger from the hardware or software buttons. All of these basic user interactions or basic user events need to be detected by the hardware and software. Hardware and software buttons are therefore at particular software level considered identical. From user interaction point of view they are to be considered even.

Depending on the used service application the user given selection and command from the terminal interface, the given command may affect the application content information of the service used by the group members. The authenticated group member may change the notice board content according to given command in such a way, that other authorized members of the same group get the latest notice board information from the server 28.

The present system is particularly designed to allow families to have access to a common data source. In this sense, a family may be an actual traditional family unit with a mother, father and children or it may merely be a group of people who have some common interest and who need information shared between them. It may also be a group of unrelated people living in the same household or it could even be a group of people having a common interest, such as a business or hobby. No matter what the makeup of the family, there is a group of data associated therewith which is open for all members of the family to see. The members of the family also have access to the database in order to add information thereto.

Accordingly, when the user is authenticated, it is determined if he is a member of a family so that he is given access to the family database as well as any personal database he may have entered. If he is a member of a family, he will be given access to several parts of the database.

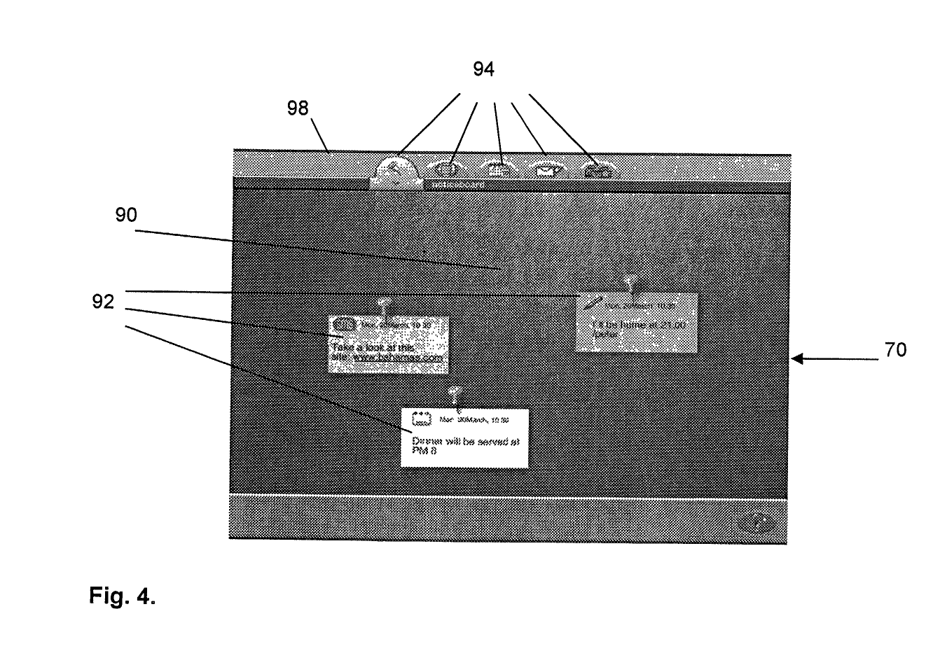

FIG. 4 shows the main screen of this data, which is referred to as the bulletin board or notice board for the family. In FIG. 4, the display 70 of the terminal includes a main central section 90 which resembles a physical bulletin board, such as a traditional cork board surrounded by wood frame which often is used to post notices in homes or offices. In a fashion similar to a physical bulletin board, notes 92 are displayed on the board. However, in this case, the notes are electronic notes, which are generated by the server and displayed as typewritten characters in a rectangular box in order to resemble a sticky note.

In addition to the notes, the display includes tabs 94 along the top of the board 90. These tabs allow for different displays to be generated upon their actuation. The main and default setting is for the bulletin board as is presently described. The actuation of other tabs will produce different displays and also allow family members to actuate databases in accordance with those displays. FIG. 4 notes four additional tabs, which actuate different database displays. Thus, the second tab includes a globe, which indicates bookmarks to various internet locations, which may be of interest to the user. A third tab includes a calendar, which produces a display relating to dates of interest for the family. The fourth tab shows a symbol of an envelope to indicate that email for the family may be displayed. The fifth tab, which shows an image of people, provides a database of address lists and other pertinent data for people who are important to the family. These other four databases are subjects of other patent applications.

The left side of the display includes a series of boxes 96 in different colors. These colored boxes are used to designate the color of a note, which is posted on the board as will be described later.

A button 98 is displayed in the upper left hand corner and is called the object menu button. This is not a physical button, but rather a displayed soft button, which may be actuated by touching it. This button allows an object menu to be accessed for various functions related to this display.

The notes, which are posted on the bulletin board, may have various colors and indicia to identify various parameters. For example, three different indicia may be displayed in the upper left hand corner of the note to indicate whether this is a note placed there manually by one of the family members, as indicated by a pencil, whether it is a note that is generated automatically by the calendar function as indicated by the small calendar or whether this is a note generated by the short message service of the wireless device from the outside as indicated by SMS. In addition, a date and time may be generated which indicates when the note was formulated. Notes may also be automatically generated by the calendar as a reminder. In general the group of members like a family may have several shared applications e.g. e-mail or calendar of which each service application may input event information to notice board in such a way, that a new notice event is created and shown visibly in the notice board area on the view of the terminal.

The notes may be of different colors to indicate different data. In one scheme, for example, a different color may indicate who has generated the note. In another scheme, the colors may indicate a subject matter. For example, a red note means an urgent notice, a green note may mean an entertainment event and a blue note may indicate shopping needs. In addition to colors, other kinds of figures, patterns of figures or markings may be made to separate and identify the notes according to chosen rules.

Each note may also include an icon such as a pin or thumbtack to make the note look more realistic. However, this may also be omitted if desired. It is also possible to arrange the notes in various orders on the board. For example, it may be possible to sort the notes according to subject matter, urgency, author, etc. It is also possible to move the notes around the board with direct manipulation such as drag ‘n’ drop. (See related application, Attorney Docket No. 017.38954X00). In this type of system, a finger or wand is used to select a note by touching it and then direct its movement by lightly dragging it into its new location and indicating the end by touching it again. This is similar to the click and drag technique used in computers having a mouse. However, this solution is used for devices, which do not have a mouse but do have an interactive screen. Such a touch screen is described in U.S. patent application Ser. No. 09/607,638. It is also possible to have a grid on which the notes are placed rather than have them pinned randomly to the board. It is also possible to overlap the notes in order to obtain additional space.

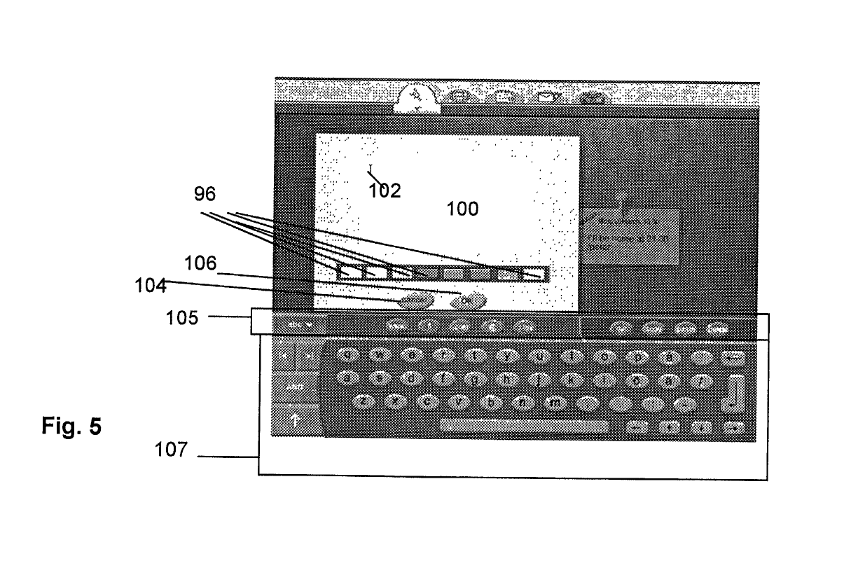

When a user wishes to create a new note, he presses one of the colored boxes 96 on below the text editing section of e of the screen. These act as buttons on the touch screen and cause the screen to change to that shown in FIG. 5. This display includes a new note 100. It includes a cursor 102 to indicate location as in a standard keyboard or a virtual keyboard. The virtual keyboard 107 in FIG. 5 is described in patent application U.S. Ser. No. 09/607,359. Also soft buttons in a marked screen area 105 in FIG. 5 are to present certain command or specific character or set of characters, that are available for the user, are included in the virtual keyboard The note, which may be generated, has a limit of a number of characters so that notes are not overly long. For example, the note may have a limit of 160 characters. The outer frame of the note includes the color selected in pushing the button 96 and which will be the background color of the final note when it is formed. The new note frame also has two virtual buttons on the lower edge 104 and 106. Button 104 causes the cancellation of the new note. Button 106 causes the note to be added to the database and displayed. It is also possible to change the color of the note in a similar fashion. It is possible to have audio indicators when a note is edited or when the color or other parameters are changed.

When a new note is displayed, the touch screen will also display a virtual keyboard so that touching the screen can generate characters. Such a touch screen and keyboard are described in U.S. patent application Ser. No. 09/607,638.

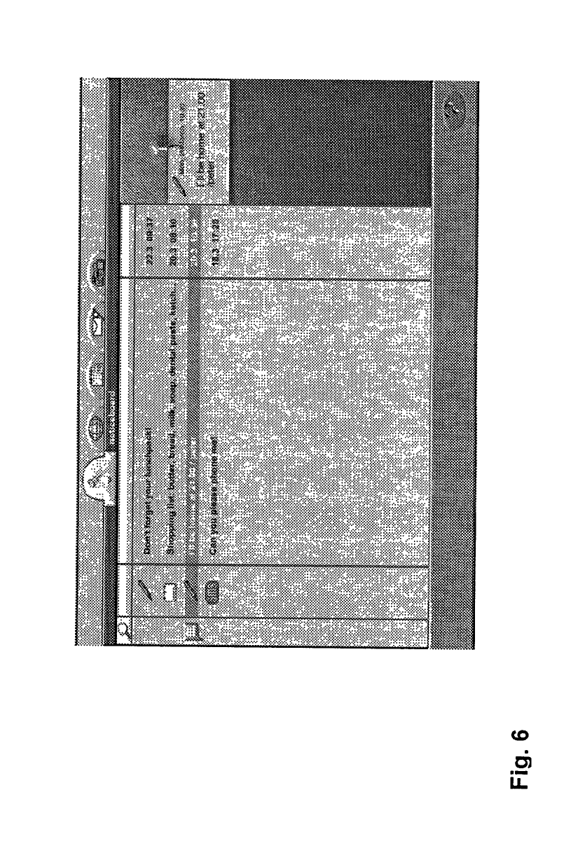

FIG. 6 shows an additional view, which may be generated by the use of the object menu button. This view is a listing of notes along with information concerning when it was generated and how long it should be available. When the end time for the note occurs, it no longer appears on the board, but is retained on the list for an additional time. By retaining it on the list, it is possible to add it back to the board if it is needed again.

Other functions for handling the notes, their generation and their instruction, may be added by various views accessed through the object menu button.

Numerous additional modifications and variations of the present invention are possible in light of the above teachings. It is, therefore, to be understood that within the scope of the appended claims, the invention may be practiced otherwise than as specifically described herein.

1. An electronic bulletin board system comprising:
a plurality of wireless devices;
an access point in wireless communication with said wireless devices;
a server connected to said access point;
said wireless devices being connected to said server through said access point in order to obtain bulletin board data there from, each of said plurality of wireless devices having equal access to said bulletin board data.

2. The system according to claim 1, further comprising a service provider connected to said access point for providing access to a communication network from said wireless devices.

3. The system according to claim 2, wherein the network is the internet.

4. The method according to claim 3, wherein at least one said plurality of wireless devices is connected to said server through a second access point, a second service provider and the Internet.

5. The system according to claim 1, further comprising a global address server connected to said access point through which said wireless devices can obtain an address of said server.

6. The system according to claim 1, wherein said bulletin board data is displayed on said wireless devices to resemble a physical bulletin board having notes attached thereto.

7. The system according to claim 6, wherein said notes are of different colors and may have indicia indicating their source.

8. The system according to claim 6, wherein said display is changed to introduce a new note, which is typed on a virtual keyboard.

9. The system according to claim 6, wherein said display is changed to introduce a new note which is received from a service, that is shared with the each of said plurality of wireless devices having equal access to the service.

10. The system according to claim 6, where in said indicia of the source is short message service.

11. A wireless family bulletin board comprising:
a server containing bulletin board data, said data including a plurality of messages;
a plurality of wireless devices, forming a family;
said wireless devices being wirelessly connected to said server so as to provide each of said plurality of wireless devices with equal access to said bulletin board data and to allow each of said plurality of wireless devices the ability to add new data thereto.

12. The bulletin board according to claim 11, wherein said notes have different colors.

13. The bulletin board according to claim 11, wherein said notes have indicia indicating their source.

14. The bulletin board according to claim 11, wherein new notes are formed by said wireless devices using a virtual keyboard.

15. The bulletin board according to claim 11, wherein the bulletin board data includes a list view of all messages.

16. A method of accessing a family bulletin board comprising:
providing a server containing bulletin board data;
wirelessly connecting a plurality of wireless devices to said server;
accessing said bulletin board data from said wireless devices;
displaying said bulletin board data on said wireless devices as notes arranged on a screen.

17. The method according to claim 16, wherein said notes have different colors and indicia indicating their origin.

18. The method according to claim 16, wherein said wireless devices are connected to said server through an access point.

19. The method according to claim 18, wherein said access point is connected to said server through a service provider connected to the Internet.

20. The method according to claim 17, wherein said wireless devices contain the address of a global address server and said wireless devices access the global address server to obtain the address of the server in order to connect thereto.

21. A system for providing notice board service and communication service in a computer network, comprising:
a terminal with an identifier,
a gateway from the terminal to the communication services,
an access point connected to the gateway through which the terminal is accessed to the communication service,
a server connected to the gateway, the server having information of the valid identifiers of the terminals enabling service, and
a configuration tool in the server for managing at least some of configurable controlling functions of a browser from the terminal.

22. A system for providing a portable user terminal with a notice board service and a communication connection to the network, that includes information management services and user services in the network, wherein the system comprises:
at least one terminal that is part of a group and capable of wireless communication, wherein a group is defined as a group having at least one terminal therein;
a gateway coupled to the terminal for providing a wireless communication link to the terminal;
a server coupled to the gateway for providing services and information management services to the terminal and providing; and
a global unit coupled to the gateway for providing the address of the network unit, wherein activation of the terminal initiates a request to the terminal is done in order to establish a shared communication session.
